(19) United States
(12) Patent Application Publication
(10) Pub. No.: US 2024/0381162 A1
(43) Pub. Date: Nov. 14, 2024

(54) DYNAMIC SELECTION AND PRESERVATION OF TID-TO-LINK MAPPING IN MULTI-LINK OPERATIONS

(71) Applicant: Cisco Technology, Inc., San Jose, CA (US)

(72) Inventors: Jegan Manoharan, Karnataka (IN); Vishal Satyendra Desai, San Jose, CA (US); Sachin D. Wakudkar, St-Sulpice (CH)

(21) Appl. No.: 18/358,755

(22) Filed: Jul. 25, 2023

(30) Foreign Application Priority Data
May 13, 2023 (IN) 202341033811

(51) Int. Cl. H04W 28/02

(52) U.S. Cl. CPC H04W 28/0263

(57) ABSTRACT

MLO management techniques are disclosed for preserving TID to link mapping and associated TID commitments. A method includes determining existing TID to link mapping for communication between at least one non-AP MLD and at least one AP MLD, the at least one non-AP MLD and one AP MLD communicating over a MLO based communication network; detecting a trigger for modifying the existing TID to link mapping; and upon detecting the trigger, determining a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

### RELATED APPLICATION DATA

This application claims the benefit of priority to Indian Provisional Patent Application No. 202341033811, filed May 13, 2023 and entitled “DYNAMICALLY SELECTING AND PRESERVING TRAFFIC IDENTIFIER-TO LINK MAPPING ACROSS MULTI-LINK STATIONS,” the disclosure of which is herein incorporated by reference in its entirety.

### TECHNICAL FIELD

The present disclosure relates to wireless communication systems operating using Multi-Link Operation technology, and in particular to preserving Traffic Identifier to link mapping between access points and end devices connected thereto, when link conditions change.

### BACKGROUND

Multi-Link Operation (MLO) is a Wi-Fi technology that enables devices connected to a Wi-Fi access point (AP) to simultaneously send and/or receive data across different frequency bands and channels. IEEE 802.11 defines a traffic identifier (TID) to classify a packet for differentiated service(s). The TID is represented as a bit number (0-7) identifying the desired quality of service (QoS) for the traffic. In MLO, the TID is used to determine which link(s) to use for traffic with a specific QoS.

In MLO, links can be added and deleted dynamically. However, this dynamic determination can adversely affect a given TID if a link to which the given TID is mapped is affected during the dynamic modification to the MLO links.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows a block diagram of an example wireless communication network according to some aspects of the present disclosure;

FIG. 2A is a network diagram illustrating an example network environment of multi-link operation, according to some aspects of the present disclosure;

FIG. 2B depicts an illustrative schematic diagram for multi-link operation between two logical entities, in accordance with one or more example embodiments of the present disclosure;

FIG. 2C depicts an illustrative schematic diagram for multi-link operation between APs with logical entities and a non-AP with logical entities, according to some aspects of the present disclosure;

FIG. 3 illustrate a visual comparison between an example static TID to link mapping, according to some aspects of the present disclosure;

FIGS. 4A-B illustrate examples of dynamic TID to link mapping, according to some aspects of the present disclosure;

FIG. 5 illustrates an example scenario of non-AP MLD roaming between two AP MLDs with static TID to link mapping, according to some aspects of the present disclosure;

FIG. 6A illustrates an example of a symmetric MLO TID to link mapping after roaming, according to some aspects of the present disclosure;

FIG. 6B illustrates an example of a asymmetric MLO TID to link mapping after roaming, according to some aspects of the present disclosure;

FIG. 7 illustrates an example method of dynamic TID to link mapping, according to some aspects of the present disclosure; and

FIG. 8 shows an example of a system for implementing certain aspects of the present technology, according to some aspects of the present disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to an MLO management techniques whereby TID to link mapping between one or more Access Point Multi-Link Devices (AP MLDs) and one or more non-AP MLDs (may also be referred to as STA MLDs or simply connected end devices) are preserved when link conditions change (e.g., during dynamic link reconfiguration where MLO links are added, deleted, over-utilized, and/or otherwise modified, during roaming of non-AP MLDs between different AP MLDs, etc.).

In one aspect, a method includes determining, by a network controller, existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network; detecting, by the network controller, a trigger for modifying the existing TID to link mapping; and upon detecting the trigger, determining, by the network controller, a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

In another aspect, the trigger is a change in a number of links available for the MLO between the at least one non-AP MLD and the at least one AP MLD.

In another aspect, the change is deletion of at least one link or addition of at least one new link for the MLO between the at least one non-AP MLD and the at least one AP MLD.

In another aspect, the trigger is over utilization of at least one link used in the existing TID to link mapping.

In another aspect, the trigger is roaming of the at least one non-AP MLD to one or more new AP MLDs.

In another aspect, the method further includes configuring one or more of the at least one non-AP MLD, the at least one AP MLD, and one or more new AP MLDs to which the at least one non-AP MLD may be connected, with the new TID to link mapping.

In one aspect, a network controller includes one or more memories having computer-readable instructions stored therein and one or more processors. The one or more processors are configured to execute the computer-readable instructions to determine existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network; detect a trigger for modifying the existing TID to link mapping; and upon detecting the trigger, determine a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

In one aspect, one or more non-transitory computer-readable media include computer-readable instructions, which when executed by one or more processors of a network controller, cause the network controller to determine existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network; detect a trigger for modifying the existing TID to link mapping; and upon detecting the trigger, determine a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

### EXAMPLE EMBODIMENTS

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every 5 years with its own characteristic features. In the earlier generations, the focus was primarily higher data rates, but with ever increasing density of devices, area efficiency has become a major concern for Wi-Fi networks. Due to this issue, the last (802.11be (Wi-Fi 7)) amendments focused more on efficiency. The next expected update to IEEE 802.11 is coined as Wi-Fi 8. Wi-Fi 8 will attempt to further enhance throughput and minimize latency to meet the ever growing demand for the Internet of Things (IoT), high resolution video streaming, low-latency wireless services, etc.

Multiple Access Point (AP) coordination and transmission in Wi-Fi refers to the management of multiple access points in a wireless network to avoid interference and ensure efficient communication between the client devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links. STAs may also be referred to as non-AP devices.

A multi-link device (MLD) may have several “affiliated” devices, each affiliated device having a separate PHY interface, and the MLD having a single link to the Logical Link Control (LLC) layer. In the proposed IEEE 802.11be draft, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11be draft. An idea behind this information element/container is to provide a way for multi-link devices (MLDs) to share the capabilities of different links with each other and facilitate the discovery and association processes. However, this information element may still be changed or new mechanisms may be introduced to share the MLO information (e.g. related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features proposed to improve the performance of Wi-Fi networks in the upcoming IEEE 802.11be amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

As noted above, in MLO, links can be added and deleted dynamically. However, this dynamic determination can adversely affect a given TID if a link to which the given TID is mapped is affected during the dynamic modification to the MLO links. Current TID to link mapping mechanism in the context of MLO suffer from the following deficiencies:

First, during MLO setup procedure, a device on link 1 may negotiate TID A which is at the higher level (e.g., over a higher frequency band such as 5 GHz or 6 GHz that can deliver a higher throughput) over TID B which is negotiated on link 2 as a lower level (e.g., over 2.4 GHz). This may be referred to as an example of a static version of a TID to link mapping. During link reconfiguration, link 1 may be disabled resulting in TID A being lost. TID A should be carried over to link 2 but current standard procedures do not allow for this to occur as the mapping is static.

Second, during roaming, when the number of links are not symmetric across roaming then TID to link mapping needs to be re-negotiated which results in management overhead. Furthermore, a non-AP MLD can roam between an AP MLD and a non-multi-link APs and vice versa, where the TID to link mapping cannot be maintained.

Third, TID to link mapping currently does not take into account actual radio resources available on the AP MLD(s) and/or non-AP MLD(s).

Fourth, an AP can send TID to link mapping to a non-AP MLD. However, accepting the TID to link mapping on the non-AP MLD side depends on the link to which a TID is mapped being available at the non-AP MLD.

Fifth, a particular TID to link mapping may result in an over utilization of the link, which current load-balancing and static TID to link mappings fail to remedy.

To address the deficiencies numerated above, among other things, aspects of the present disclosure are directed to an MLO management component (which can be implemented on AP MLDs, Wireless Local Area Network Controller (WLC), etc.) that can determine TID to link mapping between one or more Access Point Multi-Link Devices (AP MLDs) and one or more non-AP MLDs (may also be referred to as STA MLDs). Using these existing mappings as well as various other radio resource capabilities of links, flow characteristics of communications over such links, among other things, a TID service can dynamically reconfigure TID to link mapping during (1) dynamic link reconfiguration (e.g., when MLO links are added, deleted, over-utilized, and/or otherwise modified), and (2) during roaming of non-AP MLDs between different AP MLDs, in order to ensure that QoS requirements and TID commitments are maintained post link reconfiguration, post-roaming, etc.

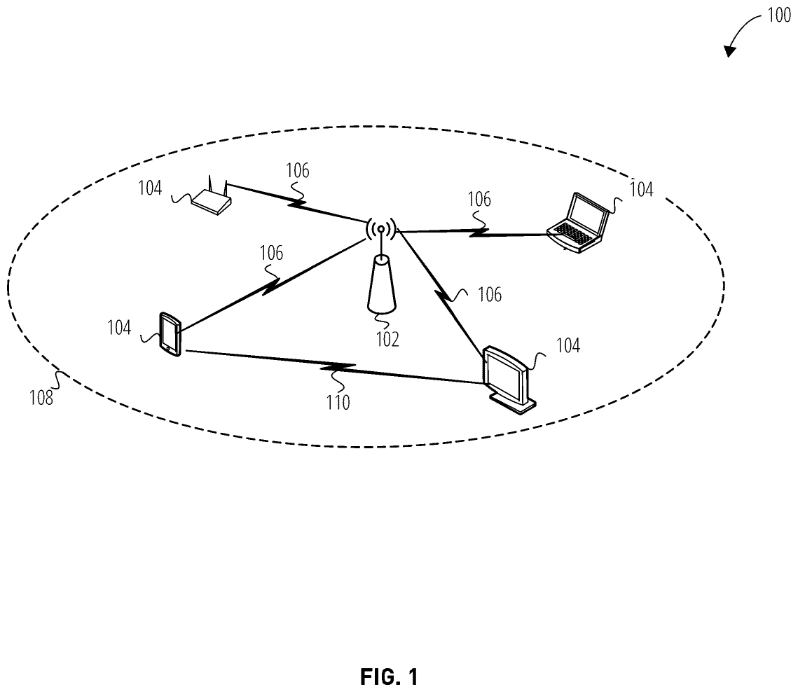

FIG. 1 shows a block diagram of an example wireless communication network according to some aspects of the present disclosure. Wireless communication network 100 can be an example of a wireless local area network (WLAN) such as a Wi-Fi network (and will hereinafter be referred to as WLAN 100). For example, WLAN 100 can be a Wi-Fi network operating based on any currently available or to be developed IEEE 802.11 protocols and standards (e.g., 802.11ay, 802.11ax, 802.11az, 802.11ba and 802.11be, etc.). WLAN 100 may include wireless communication devices such as an AP 102 and multiple STAs 104. The number of APs and STAs are not limited to that shown in FIG. 1 and can be more or less. Any one or more of AP 102 and STAs 104 may be capable of MLO (multi-link reception and/or transmission).

Each of STAs 104 can be any one or more of mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), IoT devices, etc.

A single AP 102 and an associated set of STAs 104 may be referred to as a basic service set (BSS), managed by AP 102.

FIG. 1 shows an example coverage area 108 of AP 102, which may represent a basic service area (BSA) of WLAN 100. BSS may be identified to users by a service set identifier (SSID), as well as to other devices by a basic service set identifier (BSSID), which may be a medium access control (MAC) address of AP 102. AP 102 can periodically broadcast beacons including BSSID to enable any STA 104 within wireless range of AP 102 to “associate” or re-associate with AP 102 to establish a communication link 106 with AP 102. For example, the beacons can include an identification of a primary channel used by respective AP 102 as well as a timing synchronization function for establishing or maintaining timing synchronization with AP 102.

To establish a communication link 106 with an AP 102, each of STAs 104 is configured to perform passive or active scans on frequency channels in one or more frequency bands (for example, the 2.4 GHz, 5 GHz, 6 GHz or 60 GHz bands). Passive scans entail an STA 104 listening for beacons transmitted by AP 102 at a periodic time interval referred to as the target beacon transmission time (TBTT) (measured in time units (TUs) where one TU may be equal to 1024 microseconds (s)). Active scans entail an STA 104 generating and sequentially transmitting probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with a selected AP 102. AP 102 assigns an association identifier to STA 104 at the conclusion of the association operations, which AP 102 can then utilize to track STA 104.

As a result of the increasing ubiquity of wireless networks, an STA 104 may have the opportunity to select one of many APs 102 within range of the STA or to select among multiple APs 102 that together form an extended service set (ESS) including multiple connected APs 102. An extended network station associated with WLAN 100 may be connected to a wired or wireless distribution system that may allow multiple APs 102 to be connected in such an ESS. As such, an STA 104 can be covered by more than one AP 102 and can associate with different APs 102 at different times for different transmissions. Additionally, after association with an AP 102, an STA 104 also may be configured to periodically scan its surroundings to find a more suitable AP 102 with which to associate. For example, an STA 104 that is moving relative to its associated AP 102 may perform a roaming scan to find another AP 102 having more desirable network characteristics such as a greater received signal strength indicator (RSSI), a reduced traffic load, etc.

In some cases, STAs 104 may form ad-hoc networks without APs 102. In some examples, ad hoc networks may be implemented within a larger wireless network such as WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication direct wireless link 110 regardless of whether both STAs 104 are associated with and served by same AP 102. In such an ad hoc system, one or more of STAs 104 may assume the role filled by AP 102 in a BSS. Such an STA 104 may coordinate transmissions within the ad hoc network. Examples of direct wireless links 110 include Wi-Fi Direct connections, connections established by using a Wi-Fi Tunneled Direct Link Setup (TDLS) link, and/or any other known or to be developed direct wireless communication scheme.

APs 102 and STAs 104 may function and communicate (via the respective communication links 106) according to the IEEE 802.11 family of wireless communication protocol standards. AP 102 and STAs 104 in WLAN 100 may transmit PPDUs over an unlicensed spectrum that can include frequency bands used by Wi-Fi technology, such as the 2.4 GHz band, the 5 GHz band, the 60 GHz band, the 3.6 GHz band, and the 900 MHz band. Some implementations of AP 102 and STAs 104 described herein also may communicate in other frequency bands, such as the 6 GHz band, which may support both licensed and unlicensed communications. AP 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz, or 6 GHz bands, each of which can be divided into multiple 20 MHz channels. PPDUs can be transmitted over a physical channel having a minimum bandwidth of 20 MHz or larger channels having bandwidths of 40 MHz, 80 MHz, 160 or 320 MHz, etc., which can be formed by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

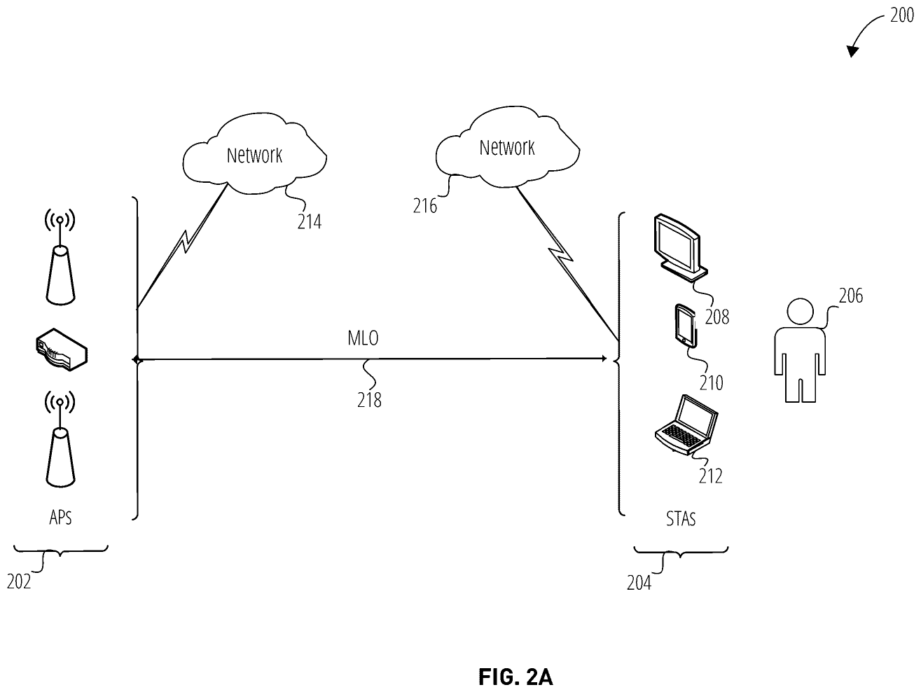

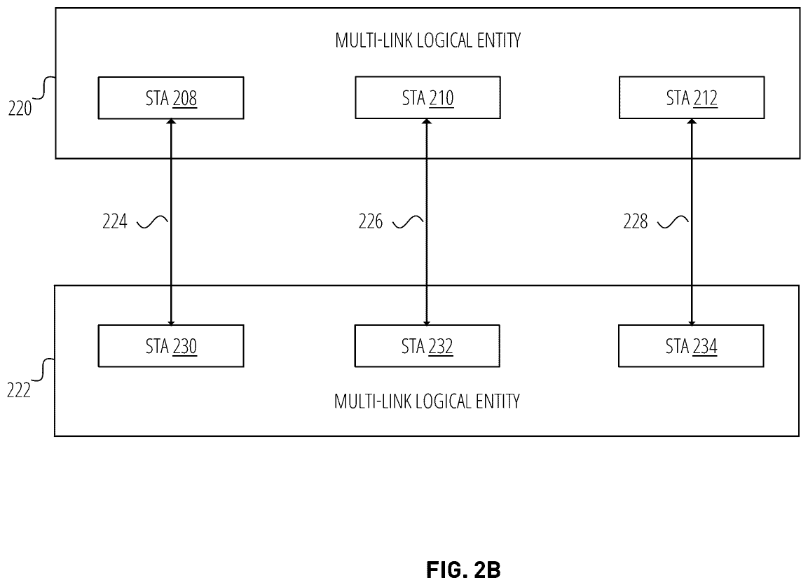

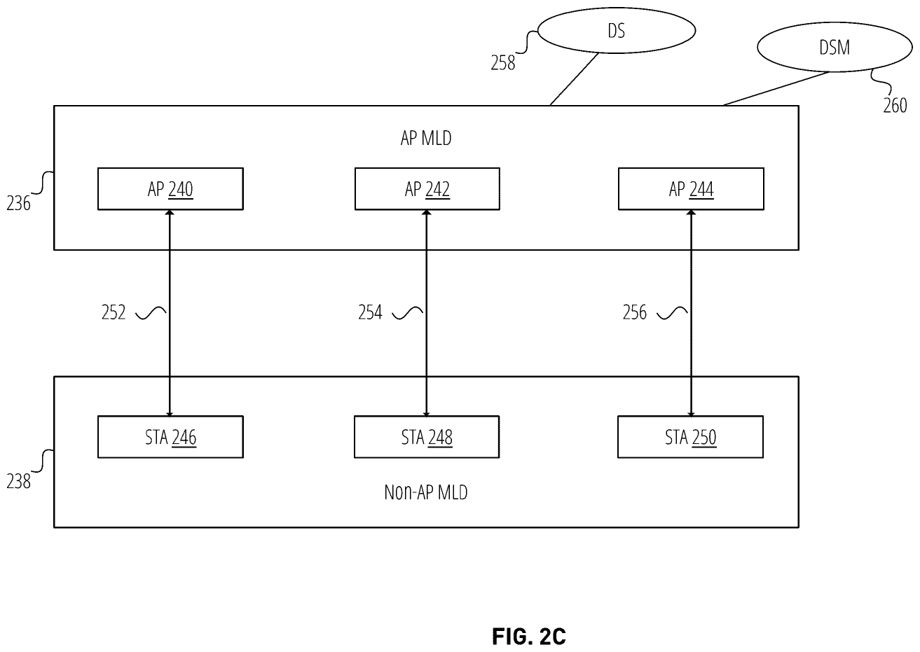

FIG. 2A is a network diagram illustrating an example network environment of multi-link operation, according to some aspects of the present disclosure. Wireless network 200 may include one or more STAs 204 (includes example devices 208, 210, and 212) and one or more APs 202, which may communicate in accordance with IEEE 802.11 communication standards. STAs 204 and APs 202 may be the same as STAs 104 and AP 102 of FIG. 1, respectively.

One or more STAs 204 and/or APs 202 may be operable by one or more user(s) 206.

STAs 204 and/or APs 202 may also include mesh stations in, for example, a mesh network, in accordance with one or more IEEE 802.11 standards and/or 3GPP standards.

Any of STAs 204 and APs 202 may be configured to communicate with each other via one or more communications networks 214 and/or networks 216, which may be the same as WLAN 100. STAs 204 may also communicate peer-to-peer or directly with each other with or without APs 202. Any of the communications networks 214 and/or networks 216 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 214 and/or networks 214 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 214 and/or networks 216 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of STAs 204 and APs 202 may be configured to perform directional transmission and/or directional reception in conjunction with wirelessly communicating in a wireless network. Any of STAs 204 and APs 202 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of STAs 204 and APs 202 may be configured to perform any given directional transmission towards one or more defined transmit sectors. Any of STAs 204 and APs 202 may be configured to perform any given directional reception from one or more defined receive sectors.

Multiple Input-Multiple Output (MIMO) beamforming in a wireless network may be accomplished using RF beamforming and/or digital beamforming. In some embodiments, in performing a given MIMO transmission, STAs 204 and/or APs 202 may be configured to use all or a subset of its one or more communications antennas to perform MIMO beamforming.

Any of STAs 204 and APs 202 may include any suitable radio and/or transceiver for transmitting and/or receiving radio frequency (RF) signals in the bandwidth and/or channels corresponding to the communications protocols utilized by any of STAs 204 and APs 202 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In some examples, and with reference to FIG. 1, APs 102 may facilitate multi-link operation 218 with one or more STAs 220.

In one example, multi-link operation 218 may have a single-radio non-access point MLD (non-AP MLD, e.g., an STA 204) listen to two or more channels simultaneously by (1) configuring a 2×2 Tx/Rx (or M×M Tx/Rx) to allocate a 1×1 resource on each channel/band (e.g., 5 GHz and 6 GHz), (2) add extra Rx modules, or (3) add wake-up receivers. An AP MLD then transmits on any idle channel a control frame (e.g., request to send (RTS) or multi-user (MU) RTS) before either a single data frame or a group of data frames within a single transmit opportunity (TXOP) to indicate that frames will be transmitted on that channel. The non-AP MLD responds back with a control frame (e.g., clear to send (CTS)). The single-radio non-AP MLD configures its radio back to 2×2 Tx/Rx module on the channel it received the control frame from the AP MLD and receives data. When using a wake-up receiver (802.11ba), the AP MLD transmits a wake-up packet. This also could be extended to other architectures with different antenna configurations. As example, a device with 3×3, when in that case a 2×2 resource on one channel and a 1×1 on another channel.

In one example, a multi-link operation 218 may enable a single-radio non-AP MLD to achieve throughput enhancement and latency reduction in a busy network without needing to implement a concurrent dual-radio, thus significantly reducing device cost.

FIG. 2B depicts an illustrative schematic diagram for multi-link operation between two logical entities, in accordance with one or more example embodiments of the present disclosure.

Referring to FIG. 2B, there are shown two multi-link logical entities 220 and 222 that can set up communication links 224, 226, and 228 with each other. A multi-link logical entity 220 or 222 may be a logical entity that contains one or more STAs such as STAs 204. The logical entity has one MAC data service interface and primitives to the logical link control (LLC) and a single address associated with the interface, which can be used to communicate on the distribution system medium (DSM). It should be noted that a Multi-link logical entity allows STAs within the multi-link logical entity to have the same MAC address. It should also be noted that the exact name can be changed.

In this example of FIG. 2B, multi-link logical entity 220 and multi-link logical entity 222 may be two separate physical devices, where each one comprises a number of virtual or logical devices. For example, multi-link logical entity 220 may comprise three STAs such as STAs 208, 210, and 212. Multi-link logical entity 222 may include another three STAs (e.g., STAs 230, 232, and 234). In one example, STA 208 may communicate with STA 230 over link 224, STA 210 may communicate with STA 232 over link 226, and STA 212 may communicate with STA 234 over link 228.

FIG. 2C depicts an illustrative schematic diagram for multi-link operation between APs with logical entities and a non-AP with logical entities, according to some aspects of the present disclosure.

Referring to FIG. 2C, two multi-link logical entities 236 and 238 are shown. AP logical entity 236 may include physical and/or logical APs 240, 242, and 244 operating in different frequency bands (e.g., 2.4 GHz, 5 GHz, and 6 GHz). APs 240, 242, and 244 can be the same as AP 102 and/or any one of APs 202 described above. Non-AP logical entity 238 may include STAs STA 246, STA 248, and STA 250, which may be the same as or similar to STAs 208, 210, 212, 230, 232, and/or 234.

AP 240 may communicate with STA 246 via link 252. AP 242 may communicate with STA 248 via link 254. AP 244 may communicate with STA 250 via link 256.

Multi-link AP logical entity 236 is shown in FIG. 2C to have access to a distribution system (DS) 258, which is a system used to interconnect a set of BSSs to create an extended service set (ESS). The multi-link AP logical entity 236 is also shown in FIG. 2C to have access a distribution system medium (DSM) 260, which is the medium used by a DS for BSS interconnections. Simply put, DS and DSM allow the AP to communicate with different BSSs.

It should be understood that although the example shows three logical entities within the multi-link AP logical entity and the three logical entities within the multi-link non-AP logical entity, this is merely for illustration purposes and that other numbers of logical entities with each of the multi-link AP and non-AP logical entities may be envisioned.

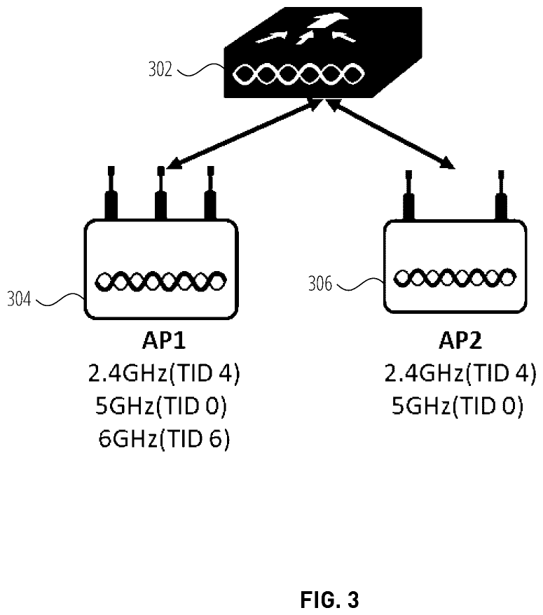

Hereinafter, example aspects of dynamic reconfiguration of TID to link mapping will be described with reference to FIGS. 3A-B to 7.

FIG. 3 illustrate a visual comparison between an example static TID to link mapping, according to some aspects of the present disclosure.

FIG. 3 shows an example wireless communication network (e.g., WiFi network) that may be the same as example network 100 described above with reference to FIG. 1 or networks of FIGS. 2A-B). This network may include network controller (e.g., a WLC) 302 that is in communication with two example AP MLDs, namely AP MLD 304 and AP MLD 306 (can be the same as AP MLDs described above with reference to FIGS. 1 and 2A-B). In this example, AP MLD 304 may be configured to support 3 frequency bands (e.g., 2.4 GHz, 5 GHz, and 6 GHz) while AP MLD 306 may be configured to support two frequency bands (e.g., 2.4 GHz and 5 GHz). In a static TID to link mapping, AP MLD 304 may have the example static TID to link mapping (e.g., TID 0 assigned to the 5 GHz link, TID 4 assigned to 2.4 GHz link, and TID 6 assigned to the 6 GHz link) mapped thereto while AP MLD 306 may have the example static TID to link mapping (e.g., TID 4 assigned to 2.4 GHz link while TID 0 is assigned to 6 GHz link).

This static TID to link mapping may suffer from the following deficiencies. For instance, the 6 GHz link on AP MLD 304 may be broken or disconnected (alternatively, may be removed as an available link by WLC 302 during dynamic link modification). This can result in TID 6 being lost.

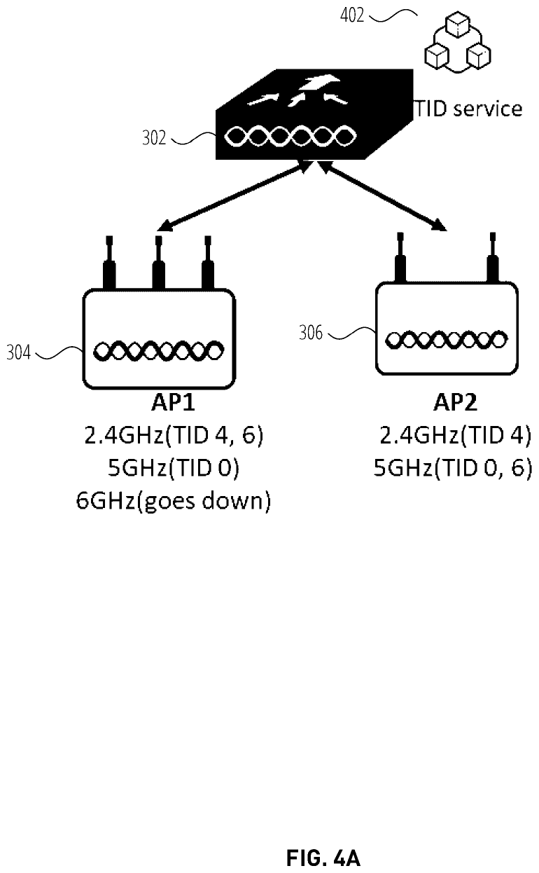

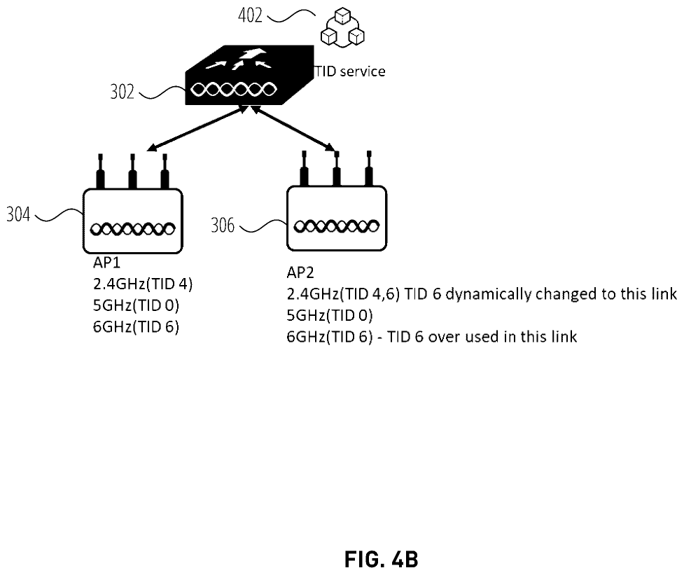

FIGS. 4A-B illustrate examples of dynamic TID to link mapping, according to some aspects of the present disclosure.

In order to address issues associated with static TID to link mapping as described above, each one of AP MLD 304 and AP MLD 306 may track TID to link mappings previously negotiated between AP MLD 304 and one or more non-AP MLDs connected thereto (e.g., one or more of x, which may also be referred to as end devices) and between AP MLD 306 and one or more non-AP MLDs connected thereto (e.g., one or more of STA 246, STA 248, and STA 250). In another example, TID service 402 on WLC 302 may keep track of such TID to link mappings.

When any given link is reconfigured (e.g., 6 GHz link goes down), TID service 402 may dynamically determine new TID to link assignments (adjust TID to link assignments) based on any number of factors including, but not limited to, link availability, TID availability on non-AP MLD(s) (e.g., connected end devices), radio resources (load) availability and utilization on each link, etc.

FIG. 4A illustrates one example of dynamically reconfigured TID to link mapping. In this example, after 6 GHz link going down, TID 6 is mapped to 2.4 GHz link on AP MLD 304 and also mapped to 5 GHz link on AP MLD 306.

In another example, an end device connected to AP MLD 304 and AP MLD 306 may not have TID 6 available thereon (e.g., the radio interface of the end connected device may not support 6 GHz connectivity). Therefore, TID Service 402 may determine a new TID to link mapping whereby TID 6 is assigned to AP MLD 306 as shown in FIG. 4A.

FIG. 4B illustrates one example of dynamically reconfigured TID to link mapping. In this example, TID to link mapping of FIG. 4A may be further adjusted based on network resources available. For example, TID Service 402 may determine that 6 GHz link is over used for TID 6 such that it cannot adequately meeting QoS requirements associated with TID 6. Therefore, TID Service 402 may modify the TID to link mapping such that TID 6 is changed to the 2.4 GHz (or alternatively serviced on both 2.4 GHz and 6 GHz links).

Static TID to link mapping is also problematic in cases where end devices (non-AP MLDs) roam between different AP MLDs. For instance, during roaming, when the number of links are not symmetric across roaming then static TID to link mapping is re-negotiated which results in management overhead. Also, non-AP MLDs can roam between AP MLDs as well as non-multi-link APs and vice versa, where the TID to link mapping cannot be maintained.

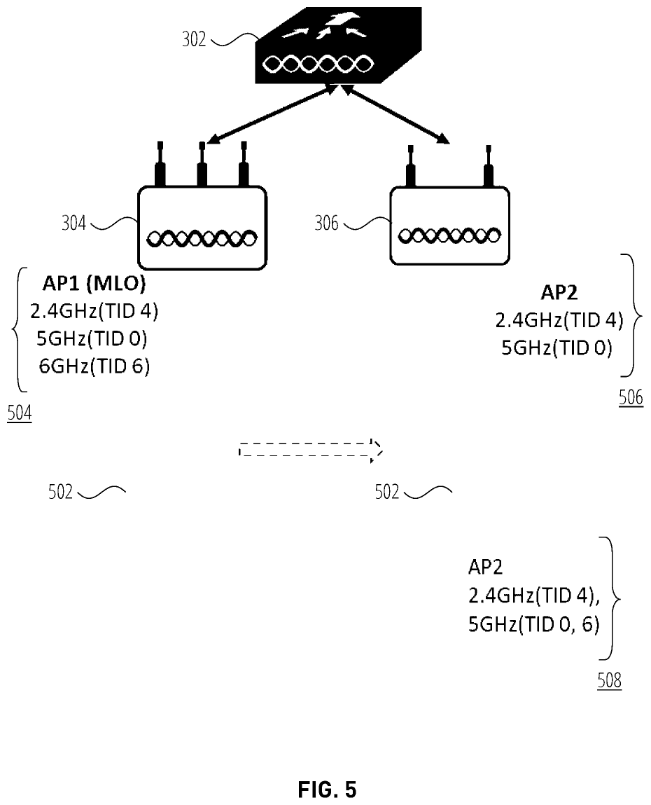

FIG. 5 illustrates an example scenario of non-AP MLD roaming between two AP MLDs with static TID to link mapping, according to some aspects of the present disclosure. As shown in FIG. 5, non-AP MLD 502 may be connected to AP MLD 304 with a static TID to link mapping 504 configured. Non-AP MLD 502 may roam from AP MLD 304 to AP MLD 306 that may not have a 6 GHz link available. Statically configured TID to link mapping 506 may result in TID 6 traffic being dropped/de-prioritized.

In another example, roaming may trigger renegotiation of TID to link mapping (e.g., example TID to link mapping 508) in a re-association request of non-AP MLD 502 with AP MLD 306. This may result in added signaling and management overhead, which is not desirable.

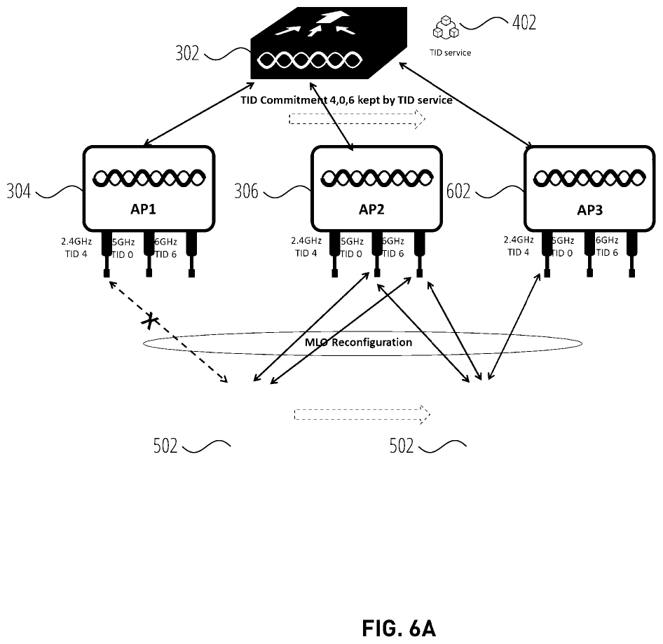

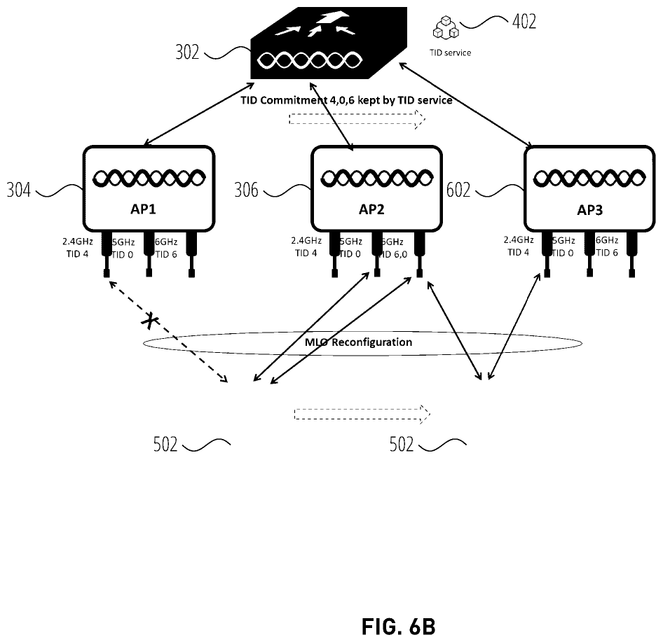

FIG. 6A illustrates an example of a symmetric MLO TID to link mapping after roaming, according to some aspects of the present disclosure. Example of FIG. 6A includes one additional AP MLD 602 in addition to AP MLD 304 and AP MLD 306.

In this example, AP MLD 304 and AP MLD 306 advertise existing TID to link mapping for 502, to WLC 302. In addition, non-AP MLD 502 may advertise its TID capabilities (e.g., radio interfaces available on non-AP MLD 502). In the non-limiting example of FIG. 6A, the existing TID to link mapping for non-AP MLD 502 (when connected to AP MLD 304 and AP MLD 306) includes TID 4 on 2.4 GHz with AP MLD 304, TID 0 on 5 GHz link with AP MLD 306, and TID 6 on 6 GHz link with AP MLD 306.

Non-AP MLD 502 may then roam from AP MLD 304 to be connected to AP MLD 306 and AP MLD 602. In this example, TID Service 402 may have a global view and knowledge of all existing TID to link mappings across and TID capabilities of non-AP MLD 502. Accordingly, TID Service 402 can direct AP MLDs 306 and AP MLD 602 to configure new TID to link mapping for non-AP MLD 502 such that the same TID commitment that existed between non-AP MLD 502 and AP MLD 304/AP MLD 306, is maintained for non-AP MLD 502 when roaming on AP MLD 306 and AP MLD 502. This new symmetric TID to link mapping (MLO reconfiguration) is symmetric since the TID 0 and TID 6 on 5 GHz and 6 GHz are maintained between non-AP MLD 502 and AP MLD 602 while TID 4 commitment on 2.4 GHz link that existed between non-AP MLD 502 and AP MLD 304 is now configured on 2.4 GHz link between non-AP MLD 502 and AP MLD 306

FIG. 6B illustrates an example of a asymmetric MLO TID to link mapping after roaming, according to some aspects of the present disclosure. In comparison to FIG. 6A, the reconfigured TID to link mapping (after non-AP MLD 502 roams from AP MLD 304/AP MLD 306 to AP MLD 306/AP MLD 602), is asymmetric. As can be seen from FIG. 6B, during the initial association of non-AP MLD 502 with AP MLD 304 and AP MLD 306, the TID to link mapping includes TID 4 on 2.4 GHz with AP MLD 304, TID 0 on 5 GHz link with AP MLD 306, and TIDs 0 and 6 on 6 GHz link with AP MLD 306.

After roaming and when non-AP MLD 502 associates with AP MLD 306 and AP MLD 602, TID 0 on the 5 GHz link with AP MLD 306 is no longer available and TIDs 0 and 6 are both on the 6 GHz link with AP MLD 306. TID 4 is moved to 2.4 GHz link on AP MLD 602. In one example, such asymmetric. This may be due to load balancing needs given the amount of network resources available, link over utilization, etc.

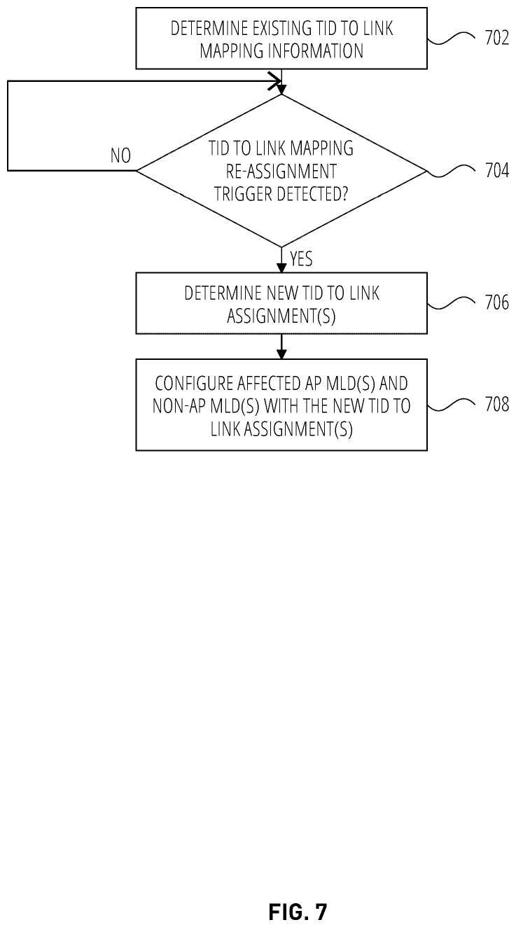

FIG. 7 illustrates an example method of dynamic TID to link mapping, according to some aspects of the present disclosure. FIG. 7 will be described from the perspective of WLC 302 that implements TID Service 402. It should be understood that WLC 302 may have one or more memories having computer-readable instructions stored therein and one or more processors configured to execute the computer-readable instructions to implement steps of FIG. 7 as described below. In other examples, TID Service 402 may be implemented at each AP MLD (e.g., AP MLD 304, 306, 602, etc.).

At step 702, WLC 302 may determine existing TID to link mapping information between at least one non-AP MLD and at least one AP MLD, wherein the at least one non-AP MLD and the at least one AP MLD are communicating over an MLO based communication network (e.g., WiFi 7 network, WiFi 8 network, etc., as described above). In one example, existing TID to link mapping information can include, but is not limited to, existing TID to link mapping between any given AP MLD and one or more non-AP MLD(s) connected thereto. For instance, WLC 302 may receive existing TID to link mapping negotiated between AP MLD 304 and non-AP MLD 502 as described above with reference to FIGS. 3-6.

In one aspect, the existing TID to link mapping may be provided to WLC 302 in a sorted order. For example, non-AP MLD 502 can instruct WLC 302 that TID 6 is mapped to that it had TIDA mapped to 5 GHz and 6 GHz links, TID 6 is mapped to 6 GHz link, etc. In addition, non-AP MLD 502 can provide additional flow information to WLC 302 such as number of latency sensitive flows, number of latency tolerant flows, etc.

TID to link mapping may be provided to WLC 302 by AP MLDs connected to WLC 302 and/or by non-AP MLDs connected to respective AP MLDs. Furthermore, such mappings can be provided (1) upon being negotiated between any given AP MLD and non-AP MLD connected thereto, (2) may be regularly queried by WLC 302, (3) may be provided to WLC 302 upon detection of a triggering event (e.g., re-association request sent by a non-AP MLD, detection of a roaming event, link reconfiguration, and/or any other triggering event/definition that may be set).

At step 704, WLC 302 may determine whether a trigger for re-assigning (modifying) existing TID to link mapping is detected. In other words, WLC 302 may determine if existing TID to link mapping received at step 702 should be updated/changed.

Any number of factors may constitute a trigger for re-assignment of existing TID to link mapping(s) is/are triggered. In one example, over utilization of existing links (e.g., as described with reference to FIG. 4B) may trigger a re-assignment of existing TID to link mapping(s). In another example, the trigger can be deletion of a link (or when a link goes down) used in the existing TID to link mapping and/or when a new link for MLO is added to links available for the MLO between the at least one non-AP MLD and the at least one AP MLD. In another example, the trigger can be the detection of a roaming event whereby a non-AP MLD such as non-AP MLD 502 roams from one or more existing AP MLDs to another one or more AP MLDs (e.g., as described with reference to FIGS. 6A and 6B), then an affected TID to link mapping may need to be re-assigned.

If at step 704, WLC 302 does not detect a trigger for TID to link mapping re-assignment, step 704 may be repeated until one or more triggers are detected.

Upon detecting a trigger, at step 706, WLC 302 determines one or more new TID to link assignment(s). Because WLC 302 has a global view of all AP MLDs and associated non-AP MLDs connected thereto, at any given point in time, more than one existing TID to link mapping may need to be updated.

In one aspect, a new TID to link assignment is determined such that one or more TID commitments of a corresponding existing TID to link mapping (determined at step 702) is/are maintained in the new TID to link mapping.

For example, the new TID to link mapping may be determined such that the highest TID on the existing TID to link mapping received at step 702 is carried over to the highest link available (e.g., after link reconfiguration as described above with reference to FIG. 4A). In another example, re-assignment is determined such that TID traffic on an overused link is redistributed (load-balanced) on two or more links (e.g., as described above with reference to FIG. 4B).

In cases where a non-AP MLD such as non-AP MLD 502 roams from one or more existing AP MLDs to one or more new AP MLDs (e.g., from AP MLD 304 to AP MLD 306 as described with reference to FIG. 5 and/or from AP MLD 304/AP MLD 306 to AP MLD 306/AP MLD 602 as described with reference to FIGS. 6A and 6B), the re-assignment may be determined such as that existing symmetric and/or asymmetric TID to link configuration for the roaming device is maintained after re-association with the new AP MLD(s).

In some examples, because WLC 302 is also privy to information such as latency sensitivity and/or tolerance of flows for different application(s) and/or non-AP MLD(s) (e.g., received at step 702), the new TID to link mapping may be determined such that the same TID commitment on exiting TID to link mapping is ensured in the new TID to link mapping. A TID commitment may be defined to include QoS associated with the TID, and one or more flow characteristics associated with the underlying non-AP MLD and/or applications used in an MLO between the non-AP MLD and one or more AP MLDs. The one or more flow characteristics can include, but are not limited to, application types, latency sensitivity and tolerance of flows to and from the underlying non-AP MLD, etc.

A number of factors have been described above that can influence the determination of new TID to link assignments at step 706. These factors can be considered alone or in combination with one another. For instance, each factor may be given a weight (determined based on experiments and/or empirical studies) and a weighted combination of factors may be used to determine the optimal redistributed of TIDs over existing links for the new TID to link re-assignment.

At step 708 and upon determining new TID to link assignment(s), WLC 302 may configure the corresponding AP MLDs and/or non-AP MLDs with the new TID to link assignment(s) such that the mapping can be used during MLO between non-AP MLD and one or more AP MLDs.

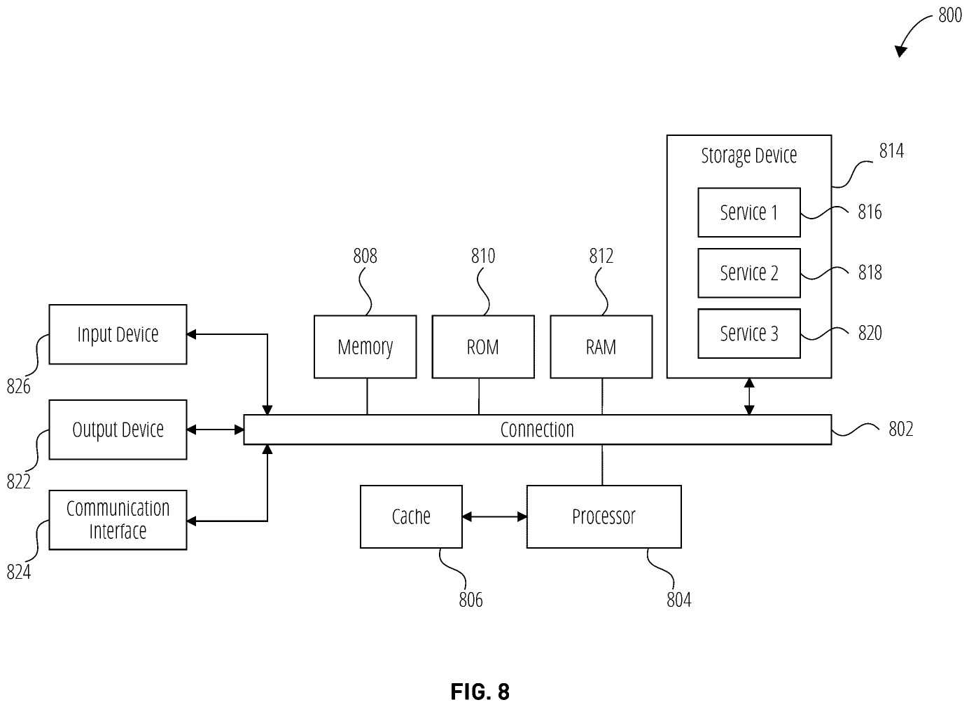

FIG. 8 shows an example of a system for implementing certain aspects of the present technology, according to some aspects of the present disclosure. FIG. 8 shows an example of computing system 800, which can be for example any computing device such as WLC 302, AP MLD(s) 304, 306, 602, non-AP MLD 502 and/or any other network component described above with reference to FIGS. 1-7. Components of example system 800 may be in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, read-only memory (ROM) 810 and random access memory (RAM) 812 to processor 804. Computing system 800 can include a cache of high-speed memory 806 connected directly with, in close proximity to, or integrated as part of processor 804.

Processor 804 can include any general purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
determining, by a network controller, existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network;
detecting, by the network controller, a trigger for modifying the existing TID to link mapping; and
upon detecting the trigger, determining, by the network controller, a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

2. The method of claim 1, wherein the trigger is a change in a number of links available for the MLO between the at least one non-AP MLD and the at least one AP MLD.

3. The method of claim 2, wherein the change is deletion of at least one link or addition of at least one new link for the MLO between the at least one non-AP MLD and the at least one AP MLD.

4. The method of claim 1, wherein the trigger is over utilization of at least one link used in the existing TID to link mapping.

5. The method of claim 1, wherein the trigger is roaming of the at least one non-AP MLD to one or more new AP MLDs.

6. The method of claim 1, further comprising:
configuring one or more of the at least one non-AP MLD, the at least one AP MLD, and one or more new AP MLDs to which the at least one non-AP MLD may be connected, with the new TID to link mapping.

7. The method of claim 1, wherein determining the existing TID to link mapping includes receiving the existing TID to link mapping from one or more of the at least one non-AP MLD and the at least one AP MLD.

8. A network controller, comprising:
one or more memories having computer-readable instructions stored therein; and
one or more processors configured to execute the computer-readable instructions to:
determine existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network;
detect a trigger for modifying the existing TID to link mapping; and
upon detecting the trigger, determine a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

9. The network controller of claim 8, wherein the trigger is a change in a number of links available for the MLO between the at least one non-AP MLD and the at least one AP MLD.

10. The network controller of claim 9, wherein the change is deletion of at least one link or addition of at least one new link for the MLO between the at least one non-AP MLD and the at least one AP MLD.

11. The network controller of claim 8, wherein the trigger is over utilization of at least one link used in the existing TID to link mapping.

12. The network controller of claim 8, wherein the trigger is roaming of the at least one non-AP MLD to one or more new AP MLDs.

13. The network controller of claim 8, wherein the one or more processors are further configured to execute the computer-readable instructions to configure one or more of the at least one non-AP MLD, the at least one AP MLD, and one or more new AP MLDs to which the at least one non-AP MLD may be connected, with the new TID to link mapping.

14. The network controller of claim 8, wherein the one or more processors are further configured to execute the computer-readable instructions to determine the existing TID to link mapping by receiving the existing TID to link mapping from one or more of the at least one non-AP MLD and the at least one AP MLD.

15. One or more non-transitory computer-readable media comprising computer-readable instructions, which when executed by one or more processors of a network controller, cause the network controller to:
determine existing Traffic Identifier (TID) to link mapping for communication between at least one non-Access Point (AP) Multi-Link Device (non-AP MLD) and at least one AP MLD, the at least one non-AP MLD and one AP MLD communicating over a Multi-Link Operation (MLO) based communication network;
detect a trigger for modifying the existing TID to link mapping; and
upon detecting the trigger, determine a new TID to link mapping for the existing TID to link mapping such that one or more TID commitments of the existing TID to link mapping are maintained in the new TID to link mapping, the one or more TID commitments including at least a Quality of Service associated with a corresponding TID and one or more flow characteristics associated with network traffic to and from the at least one non-AP MLD.

16. The one or more non-transitory computer-readable media of claim 15, wherein the trigger is a change in a number of links available for the MLO between the at least one non-AP MLD and the at least one AP MLD.

17. The one or more non-transitory computer-readable media of claim 15, wherein the trigger is over utilization of at least one link used in the existing TID to link mapping.

18. The one or more non-transitory computer-readable media of claim 15, wherein the trigger is roaming of the at least one non-AP MLD to one or more new AP MLDs.

19. The one or more non-transitory computer-readable media of claim 15, wherein the execution of the computer-readable instructions further cause the network controller to configure one or more of the at least one non-AP MLD, the at least one AP MLD, and one or more new AP MLDs to which the at least one non-AP MLD may be connected, with the new TID to link mapping.

20. The one or more non-transitory computer-readable media of claim 15, wherein the execution of the computer-readable instructions further cause the network controller to determine the existing TID to link mapping by receiving the existing TID to link mapping from one or more of the at least one non-AP MLD and the at least one AP MLD.
